(19) United States
(12) Patent Application Publication
(10) Pub. No.: US 2026/0123785 A1
(43) Pub. Date: May 7, 2026

(54) APPARATUS FOR MAKING ESPRESSO COFFEE

(71) Applicant: Presso Limited, London (GB)

(72) Inventor: Patrick Hunt, London (GB)

(73) Assignee: Presso Limited, London (GB)

(21) Appl. No.: 19/118,169

(22) PCT Filed: Oct. 3, 2023
(86) PCT No.: PCT/EP2023/077312

§ 371 Date: Apr. 3, 2025

(30) Foreign Application Priority Data
Oct. 4, 2022 (GB) 2214576.7

(51) Int. Cl. A47J 31/36; A23F 5/26; A47J 31/00; A47J 31/38

(52) U.S. Cl. CPC A47J 31/3671; A23F 5/262; A47J 31/005; A47J 31/38

(57) ABSTRACT

There is provided an apparatus for making espresso coffee comprising: a cylinder defining a cavity for receiving a liquid; a plunger axially slidable within the cavity between an inserted position and a retracted position; and an actuator comprising a biasing member for biasing the plunger towards the inserted position, wherein the actuator is adapted to change a configuration of the apparatus from a resting configuration to an actuation configuration, and wherein: in the resting configuration the plunger is at the inserted position and the biasing member exerts a minimum biasing force on the plunger; and in the actuation configuration the plunger is at the retracted position and the biasing member exerts a maximum biasing force on the plunger.

### FIELD

The present disclosure relates to an apparatus for making espresso coffee and more particularly, to an apparatus for making espresso coffee manually.

### BACKGROUND

Coffee is globally one of the world's most widely consumed beverages. It is normally drunk hot and it is made by extracting soluble components using hot water from ground coffee, i.e. a granular powder formed by grinding roasted coffee beans. It is well-known that the taste of the coffee varies significantly, even with identical ground coffee as the starting material, depending upon the precise conditions under which the extraction is carried out. One known widely used method is to pass a relatively small quantity of hot water through a compacted block of coffee grounds under relatively high pressure in order to force the water through the block. This results in a quantity of espresso coffee which is, or is a primary component of, the type of coffee beverage preferred by many users.

In order to produce espresso coffee, for example in a cafe or restaurant, it is common to use a counter-top “espresso machine”. These machines are generally provided with a plumbed-in water supply and include means for maintaining a reservoir of water at a relatively high temperature as well as complex systems for expelling a measured quantity of that hot water through a block of compressed ground coffee. The block of compressed ground coffee is held tightly against a pressurised water outlet of the machine by means of a cylindrical metal pot in which the block of ground coffee is compressed.

The block of compressed ground coffee may be of loose coffee granules put into the pot (conventionally the pot is filled to the brim, the granules then being compressed to a smaller volume before or when the pot is affixed to the machine) or may be in the form of a sachet or ‘pod’ made of water-permeable material and sized to fit snugly into the pot. The pot is provided with means to hold itself sealed tightly against the pressurised water outlet. Conventionally this is achieved by projections on the exterior of the pot engaging short thread portions on the interior of a skirt surrounding the outlet. The pot is usually provided with a laterally extending exterior handle enabling the pot to be screwed tightly into position by turning through around 90°. The base of the pot contains an aperture through which the brewed coffee may pass to drop into a cup placed below the pot during dispensing, which may be bifurcated to divide the outflow into two streams each of which then drops into a cup placed below the pot.

Apparatus of this sort provided for cafe and restaurant use is of substantial size and usually requires plumbing into a water system and is accordingly not ideally suited for domestic use. Scaled down versions of these commercial espresso machines have been manufactured for domestic use for many years, but such apparatus have conventionally required an electrical supply.

However, domestic espresso machines of this nature have a number of drawbacks. For example, domestic espresso machines are often provided with a small reservoir placed inconveniently, but necessarily, at the rear of the machine. Further, domestic espresso machines are often provided with relatively small and weak pumps for passing the water through the compressed block of coffee grounds, meaning that either the pump is quickly worn out in trying to achieve the pressures necessary to brew espresso coffee or that the necessary pressures are never achieved and the quality of the brewed coffee reduced. In addition, domestic espresso machines are often still bulky, taking up a significant amount of space in a domestic kitchen, and require a mains power supply in order to function, meaning that the machine is not portable and it is not possible to brew an espresso coffee outside of the domestic setting.

There exist several examples of espresso machines that utilize single levers, pulled by a user, to force a quantity of water through a compressed block of ground coffee. Often these machines still require mains power and/or plumbing in order to provide the heated water for the brewing of the coffee. Further, the single lever arrangement of these machines is typically unwieldy, requires a significant amount of strength from the user in order to achieve the necessary force and requires the user to be engaged with the machine for the entire length of the brewing process.

An example of an apparatus for making espresso coffee is illustrated in document EP 1509112B1, which discloses a lever operated apparatus for driving water through coffee grounds using a plunger in order to brew an espresso coffee. In this case, the user is required to provide all of the downward force in order to drive the plunger and force the water through the coffee grounds. This requires a significant amount of strength from the user in order to achieve the necessary force for brewing an espresso coffee and also requires the user to be engaged with the machine for the entire length of the brewing process.

The present disclosure has been devised in light of the above considerations.

### SUMMARY

In a first aspect, there is provided an apparatus for making espresso coffee comprising:
a cylinder defining a cavity for receiving a liquid;
a plunger axially slidable within the cavity between an inserted position and a retracted position; and
an actuator comprising a biasing member for biasing the plunger towards the inserted position,
wherein the actuator is adapted to change a configuration of the apparatus from a resting configuration in which the plunger is at the inserted position and the biasing member exerts a minimum biasing force on the plunger, to an actuation configuration in which the plunger is at the retracted position and the biasing member exerts a maximum biasing force on the plunger.

This provides a means of making espresso coffee in a semi-automated manner without requiring an electrical power supply. In order to brew the coffee, a user is required to simply use the actuator to change the configuration of the apparatus from its resting configuration to its actuation configuration, which retracts the plunger and causes the biasing force exerted on the plunger by biasing member to increase. The biasing member automatically drives the plunger towards its inserted position by way of the biasing force, thereby forcing liquid from the cavity, for example through a quantity of ground coffee, and returning the apparatus to the resting configuration.

As the biasing member, rather than the user, drives the plunger to its inserted position within the cavity, the user is not required to apply force to move the plunger the full distance between its retracted and inserted positions in order to complete the brewing process. Rather, once the user has used the actuator to change the apparatus into the actuation configuration, the apparatus automatically completes the making of the espresso coffee with no further input required from the user. Thus, the apparatus significantly shortens the length of time the user needs to interact with a manual coffee maker in order to obtain an espresso coffee. Further, the provision of the biasing member reduces the work that the user needs to do to return the plunger to its inserted position within the cavity and complete the brewing process.

The apparatus includes an actuator for changing the configuration of the apparatus from the resting configuration to the actuation configuration. The actuator is configured to slide the plunger from the inserted position to the retracted position, and for imparting potential energy to the biasing member.

The actuator may comprise an actuation element. The actuation element may be movable to change the configuration of the apparatus from the resting configuration to the actuation configuration. The actuation element may be movable in a first movement and a second movement, opposite the first movement. The actuation element may change the configuration of the apparatus from the resting configuration to the actuation configuration by a combination of the first movement and the second movement.

The actuation element may be a pivotable element (e.g. a lever) such that the first movement is a first pivoting movement and the second movement is a second pivoting movement. The first and second pivoting movements will be in opposing rotational directions to each other about a pivot.

In the first movement, the pivotable element may move from a first position where it lies against the cylinder to a second position where it is raised away from cylinder. In the second position, the pivotable element may move from the second position back to the first position. The pivotable element may rotate through an angle of approximately 180 degrees between its first and second positions.

The use of a pivotable element, such as a lever, provides the user with leverage when performing the first and second movements of the actuator, which means that the user is required to apply less force in order to perform the movements and to impart the potential energy to the biasing member. Accordingly, the ease of use of the apparatus is improved.

The at least one pivotable element may be pivotably connected the cylinder. For example, the cylinder may comprise a flange to which the at least one pivotable element is pivotably connected. The pivotable element may be pivotably connected to the cylinder by way of a pin joint. The flange may be positioned adjacent an open top of the cylinder, the open top for receiving the plunger.

The actuator may further comprise a compression plate and a base plate, between which the biasing member may be provided. Accordingly, the biasing member may be sandwiched between the compression plate and the base plate.

In the resting configuration, the compression plate and the base plate may have a maximum spacing between them and in the actuation configuration, the compression plate and the base plate may have a minimum spacing between them. Thus, the biasing member may be in a state of minimum compression between the compression plate and the base plate in the resting configuration and a state of maximum compression between the compression plate and the base plate in the actuation configuration.

The base plate may be directly or indirectly connected to the plunger (e.g. to a flange encircling a shaft of the plunger). The connector to the plunger/flange may be at or proximal the upper axial end of the plunger i.e. the axial end not received within the cavity. Accordingly, a movement of the plunger results in a movement of the base plate. Correspondingly, a movement of the base plate results in a movement of the plunger.

The orientation of the base plate may change with respect to the plunger during the change between configurations of the apparatus.

In the actuation configuration, the compression plate may be fixed relative to the cylinder and the base plate may be movable relative to the cylinder (but fixed relative to the plunger). Accordingly, the base plate may be movable by the biasing force provided by the biasing member, such that the biasing force may be applied to the plunger through the base plate in order to drive the plunger towards its inserted position and return the apparatus to the resting configuration.

The base plate may be a substantially circular plate or an annular plate.

The compression plate may be connected to the actuation element of the actuator. Accordingly, the movement of the actuation element results in a movement of the compression plate. At least the second movement of the actuation element results in a movement of the compression plate towards the base plate. The orientation of the compression plate may change with respect to the actuation element during such a movement. The compression plate may be in direct abutment with the biasing member so as to compart a compressive force to the biasing member as the apparatus changes from the resting configuration to the actuation configuration.

The compression plate may be a substantially circular plate or an annular plate.

The biasing member may be any member capable of storing and releasing potential energy. The biasing member may comprise a compressible element. The compressible element may be compressible by the compression plate approaching the base plate as the apparatus is changed to the actuation configuration from the resting configuration to impart the potential energy to the biasing member.

The compressible element may comprise a spring. The spring may be pretensioned. By providing a pretensioned spring as the biasing member, the potential drop-off in force applied by the biasing member as the plunger approaches its inserted position within the cavity, and the apparatus returns to its resting configuration, is reduced or eliminated. In this way, any potential drop in pressure towards the end of the brewing process is reduced or eliminated, thereby improving the quality of the resulting coffee. Accordingly, the minimum biasing force may be non-zero.

The biasing member, for example the compressible element such as the spring, may have an upper end in abutment with the compression plate and a lower end in abutment with a base plate. The biasing member biases the compression plate and base plate apart.

The axial distance between the compression plate and base plate is variable during the transition of the apparatus from its resting configuration to its actuation configuration in order to effect compression of the biasing member. For example, during the transition of the apparatus to its actuation configuration, the compression plate is forced towards the base plate to compress the biasing member. After compression of the biasing member, the compression plate and base plate will be at their minimum spacing and the biasing member will be at its maximum compression and therefore be applying the maximum biasing force to the base plate, the position of which is movable relative to the cylinder in the actuation configuration. The resilience in the biasing member then drives the base plate away from the compression plate. The base plate is connected (either directly or indirectly) to the plunger and thus, as the base plate is forced away from the compression plate, the plunger is forced into the cavity towards its inserted position.

The actuator may further comprise an arm having a first lateral end pivotably connected to the actuation element and a second lateral end connected to the compression plate. The pivotable connection between the actuation element and the arm results in movement of the arm relative to the actuation element during transition of the apparatus to its actuation configuration, which may be effected by the movement of the actuation element. For example, the arm may move from a vertical orientation substantially aligned with the axis of the cavity to an inclined orientation and back to the vertical orientation in the transition of the apparatus from the resting configuration to the actuation configuration. The compression plate may be fixedly or pivotably connected to the arm. The compression plate may be in a plane that is substantially perpendicular to the axis of the arm at least the actuation configuration of the apparatus.

In some embodiments, the base plate may form the base of a housing e.g. a cylindrical housing, housing compression plate the biasing member. The base plate may be annular and may comprise an opening through which the arm passes. The biasing member may circumscribe the arm within the housing. The compression plate is axially slidable within the housing to compress the biasing member within the housing against the base plate. The axial end of the housing opposing the base plate is pivotally connected to the plunger. In this way, the base plate is indirectly connected to the plunger. In these embodiments, the compression plate is preferably a circular disc which may be solid.

The housing may be pivotally connected to the flange encircling the plunger i.e. encircling a shaft of the plunger. The flange may be axially opposed to a head of the plunger, the plunger head being provided at the axial end of the plunger shaft which is received in the cavity.

Preferably, in these embodiments, there are two biasing members (e.g. compression elements such as springs), each biasing element associated with a respective actuation element, arm, compression plate, base plate and housing. Thus, there may be a pair of pivotable actuation elements, for example a pair of levers. The pair of pivotable elements may be arranged on opposing sides of the apparatus. For example, they may be substantially diametrically opposed i.e. separated by an angle of approximately 180° about a central axis of the cavity, which is the same axis along which the plunger slides from the retracted position to the inserted position. The use of a pair of opposing pivotable elements means that the user would need to apply less force to each pivotable element in order to change the configuration of the apparatus from the resting configuration to the actuation configuration. Accordingly, the ease of use of the apparatus may be improved.

In other embodiments, there may only be a single biasing member and the biasing member may circumscribe the plunger shaft. In these embodiments, the base plate may be annular and may encircle the plunger shaft e.g. proximal the plunger head. Thus both the biasing member and the base plate are housed within the cylinder cavity. They may be axially slidable within the cavity. The base plate in these embodiments is fixedly connected to the plunger and thus, after compression of the biasing member (when the apparatus is in the actuation configuration), the base plate is forced away from the compression plate thus driving the plunger further into the cavity into its inserted position. In these embodiments, the compression plate is annular and also encircles the plunger shaft. The compression plate may be pivotally connected to the arm.

The annular compression plate is axially slideable over the plunger shaft. For example, when the apparatus transitions between the resting position and the actuation position, the compression plate is forced towards the top opening of the cylinder and towards the base plate to minimise the spacing between the base plate and compression plate (thus compressing the biasing element). When the apparatus is in the actuation configuration, the compression plate may be in abutment with the top opening of the cylinder such that the biasing member is entirely within the cylinder cavity (between the plunger shaft and inner cylinder wall).

In these embodiments, the biasing member, base plate and compression plate may be associated with two pivotable elements and arms e.g. two diametrically opposed pivotable elements/arms, each of the pivotable elements connected to the cylinder and each of the arms connected between the respective pivotable element and the compression plate i.e. the two arms may be connected to opposing (e.g. diametrically opposing) sides of the compression plate.

In other embodiments, the biasing member may take the form of a pneumatic system or a hydraulic system.

The apparatus includes a plunger that is axially received within the cavity (through the open top of the cylinder) for receiving liquid. The plunger is axially slidable within the cavity by the movement of the actuator and under the biasing force of the biasing member.

The plunger may include a plunger shaft and a plunger head as described above. The plunger head provides a pressure surface facing the cavity for forcing liquid from a bottom opening of the cylinder.

The plunger shaft may comprise a hollow tube. The tubular plunger shaft may have the same diameter as the plunger head.

The plunger head may have a similar cross-sectional shape to the cavity, such as circular.

The plunger may include a one-way valve mechanism for allowing the liquid to pass in only one direction around the plunger head. For example, it may include a one-way valve to allow liquid to pass from above the plunger head to below the plunger head (i.e. between the pressure surface and the bottom opening of the cylinder) as the plunger moves from the inserted position to the retracted position. Thus, a user may provide the liquid to the cavity when the plunger is in the inserted position and as the first movement of the actuator is performed, and the plunger slides axially from the inserted position to the retracted position, the liquid passes from above the plunger head to below the plunger head. When the plunger is driven towards the inserted position from the retracted position, due to the one-way valve, the liquid can no longer pass through the plunger head and is forced through the coffee grounds under pressure. The one-way valve may be realised by an O-ring arrangement. The O-ring arrangement may comprise an O-ring positioned between a head of the plunger and the inner wall of the cavity, such that the O-ring rolls between an open position, where a liquid flow path in the plunger head is open, and a closed position, wherein the liquid flow path in the plunger head is closed. The one-way valve mechanism may be as described in EP 1509112B1 which is incorporated herein by reference.

The apparatus may further comprise a receptacle for locating adjacent the base of the cylinder (i.e. below the bottom opening of the cylinder) a quantity of ground coffee. The receptacle may also be adapted to accept and utilize a pre-packaged container holding a pre-defined coffee brewing mixture for making coffee. The receptacle may comprise one or more holes in the base that permit water, but not the coffee grounds, to pass through.

The receptacle for locating adjacent the base of the cylinder a quantity of ground coffee may comprise a restrictor for restricting a flow of liquid from the cavity through the quantity of ground coffee driven by the plunger moving from the retracted position towards its inserted position within the cavity. The restrictor may be a plate having a through hole, through which the liquid is passed. The through hole may be between 0.3 mm and 0.6 mm in diameter, such as 0.4 mm or 0.5 mm in diameter. The restrictor may be integral to part of the receptable for locating the ground coffee adjacent the base of the cylinder. In this way, the pressures required for brewing espresso may be achieved without having to rely on the size of the grounds of coffee provided to the apparatus by the user. The relationship between the biasing member and the restrictor, for example the relationship between the spring tension and the amount of restriction applied to the water flow, may be balanced in order to optimise the rate of extraction for the coffee. For example, the relationship between the at least one biasing member and the restrictor may be controlled to achieve a brew time of between 25 and 30 seconds.

The apparatus may further include a stand connected to the cylinder. The stand may define therein a space for receiving a container (e.g. cup or glass) for receiving the coffee. The stand may further comprise a platform on which the container for receiving the coffee may stand. The platform may comprise an external rim to contain any spillage. The platform may comprise a series of raised formations to hold a container for receiving the coffee out of contact with any spillage.

The apparatus may further comprise a pressure gauge. The pressure gauge may be provided for measuring the pressure within the cavity. For example, the pressure gauge may be provided for measuring the pressure within the cavity as the plunger is driven from the retracted position to the inserted position. The measured pressure may be provided to the user by any suitable means of display such that the user may monitor the brewing of the coffee with greater accuracy. The pressure gauge may include pressure sensor and a display. The pressure sensor and display may be integrated into a single element or provided as separate elements. The display may be a digital display or an analogue display.

In a second aspect, there is provided a method for making espresso coffee using an apparatus for making espresso coffee according to any one of the preceding claims, the method comprising: providing a quantity of liquid to the cavity of the apparatus in the resting configuration; actuating the apparatus using the actuator to change the configuration of the apparatus to the actuation configuration; driving the plunger towards its inserted position with the biasing force of the biasing member, thereby passing the liquid through a quantity of ground coffee.

The method may include locating adjacent the base of the cylinder of the apparatus a quantity of ground coffee. The cylinder defines the cavity in which liquid is received. The quantity of ground coffee may be located adjacent the base of the cylinder using the receptacle described above.

A quantity of liquid is received in the cavity of the apparatus when the apparatus is in the resting configuration. In the resting configuration, the plunger is at the inserted position and the biasing member of the actuator of the apparatus is applying a minimum biasing force to the plunger. The liquid received by the cavity may be any liquid suitable for brewing espresso coffee, such as water heated up to 100° C., for example water heated to between 90° C. to 96° C. In the case where the liquid received by the cavity is heated water the heating of the water may be performed external to the apparatus, for example by way of a kettle, a heated tap, or any other means for heating a quantity of water. Thus, the apparatus does not require any plumbing connection by which to receive the water or any electrical means of heating the water itself.

The configuration of the apparatus is then changed from the resting configuration to the actuation configuration using an actuator. In the actuation configuration, the plunger is at the retracted position and the biasing member is applying a maximum biasing force to the plunger. The plunger head may include a one-way valve mechanism for allowing the liquid to pass from above the plunger head to below the plunger head as the plunger moves from the inserted position to the retracted position as described above. Thus, as the configuration of the apparatus is changed from the resting configuration to the actuation configuration, and the plunger slides from the inserted position to the retracted position, the liquid provided to the cavity passes from above the plunger head to below the plunger head.

The biasing member biases the plunger towards the inserted position, which causes the plunger to move towards its inserted position within the cavity when the apparatus changes to the actuation configuration. In the actuation configuration, the biasing member and the plunger are the only elements not in their resting state, and so are the only elements that can move to release the potential energy held in the biasing member in the actuation configuration.

The plunger is therefore driven towards its inserted position within the cavity and the liquid held below the plunger within said cavity is thus passed through the quantity of ground coffee under pressure.

The proposed apparatus includes the combination of the aspects and preferred features described except where such a combination is clearly impermissible or expressly avoided.

### SUMMARY OF THE FIGURES

Embodiments and experiments illustrating the principles of the disclosure will now be discussed with reference to the accompanying figures in which:

FIG. 1 shows an example of an apparatus for making espresso coffee according to an aspect of the disclosure in the resting configuration.

FIG. 2 shows the apparatus of FIG. 1 during the transition from the resting configuration of the apparatus to the actuation configuration.

FIG. 3 shows the apparatus of FIG. 1 in the actuation configuration.

FIG. 4 shows a perspective view of the apparatus of FIG. 1.

FIG. 5A shows an example of a plunger head that may be utilized with the apparatus as the plunger slides from the inserted position to the retracted position.

FIG. 5B shows an example of a plunger head that may be utilized with the apparatus as the plunger slides from the retracted position to the inserted position.

FIG. 6 shows an example of an apparatus for making espresso coffee according to a further aspect of the disclosure during the transition from the resting configuration of the apparatus to the actuation configuration.

FIG. 7 shows the apparatus of FIG. 6 in the actuation configuration.

### DETAILED DESCRIPTION

Aspects and embodiments of the present disclosure will now be discussed with reference to the accompanying figures. Further aspects and embodiments will be apparent to those skilled in the art. All documents mentioned in this text are incorporated herein by reference.

There is provided an apparatus for making espresso coffee comprising: a cylinder defining a cavity for receiving a liquid; a plunger axially slidable within the cavity between an inserted position and a retracted position; and an actuator comprising a biasing member for biasing the plunger towards the inserted position, wherein the actuator is adapted to change a configuration of the apparatus from a resting configuration to an actuation configuration, and wherein: in the resting configuration the plunger is at the inserted position and the biasing member exerts a minimum biasing force on the plunger; and in the actuation configuration the plunger is at the retracted position and the biasing member exerts a maximum biasing force on the plunger.

In other words, there is provided an apparatus for making espresso coffee by passing an amount of liquid through a quantity of ground coffee under pressure by manually driving a plunger through said cavity. The plunger is driven by a biasing member, which is provided with potential energy through the use of an actuator by a user to change the configuration of the apparatus from the resting configuration to the actuation configuration. Accordingly, it is the biasing member and not the actuator itself that primarily drives the plunger through the cavity, meaning that the user is not required for driving the entire brewing process but only for priming the biasing member.

Put another way, there is provided a means of making espresso coffee in a semi-automated manner that requires no electrical connection or dedicated plumbing and requires minimal input from the user. In particular, once the user has performed the actuation of the actuator they may leave the apparatus to finish the brewing of the espresso coffee under the power of the at least one biasing member alone.

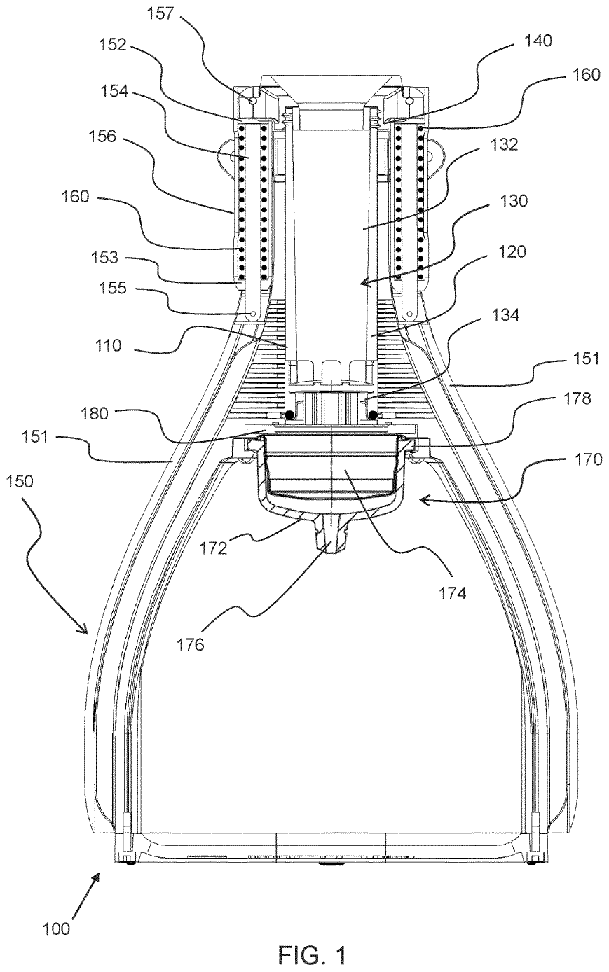

FIG. 1 shows a cross-section of an apparatus 100 for making espresso coffee according to an aspect of the disclosure. In particular, FIG. 1 shows the apparatus in the resting configuration.

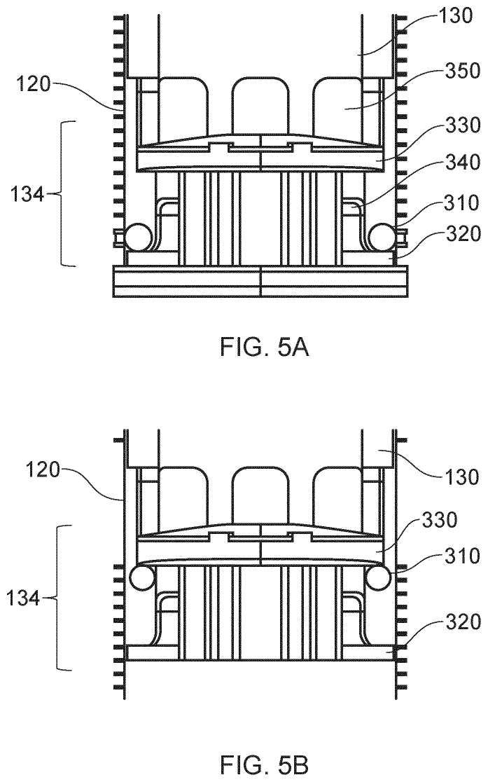

The apparatus 100 comprises a cylinder 110 defining a cavity 120 for receiving a liquid, for example by way of an opening 140 at the top of the cylinder. The apparatus further comprises a plunger 130 that is slidably received within the cavity. The plunger comprises a plunger shaft 132 and a plunger head 134. In the examples discussed herein, the cavity and plunger head are cylindrical and have a circular cross-section. FIG. 1 shows the plunger 130 in the inserted position within the cavity, i.e., in the resting configuration. The features of the plunger head 134 are described in further detail below with reference to FIGS. 5A and 5B.

The plunger 130, which is received in the cavity 120 in an axially slidable manner, is attached to an actuator 150 of the apparatus. The actuator comprises a biasing member 160 for biasing the plunger towards the inserted position. In the resting configuration, as shown in FIG. 1, the biasing member applies a minimum biasing force to the plunger. In the actuation configuration, the biasing member applies a maximum biasing force to the plunger.

The actuator may comprise an actuation element, which is an element that can be moved by a user of the apparatus to change the configuration of the apparatus from the resting configuration to the actuation configuration so as to slide the plunger from the inserted position to the retracted position. For example, when the user performs a first movement with the actuation element, the actuator may cause the plunger 130 to move from the inserted position within the cavity 120 to the retracted position.

In the examples discussed herein, the actuation element includes pivotable element pivotably connected to the cylinder, and in particular a lever 151 pivotably connected to the cylinder 110, for example to a flange on the clinger by way of a pin joint. In example shown in FIG. 1, the actuator includes a pair of levers 151 diametrically opposed on opposite sides of the cylinder 110. Accordingly, a first movement of the actuating element may comprise pivoting the levers about their connection point with the cylinder in a first direction. A corresponding second, opposite, movement would therefore comprise pivoting the levers about their connection point with the cylinder in a second direction, opposite the first direction. The use of the pair of levers reduces the force required by the user on each lever to move the plunger from one position to the other. Further, by providing a pair of levers, the action of moving the actuator is more balanced and natural for the user, thereby improving the ease of use of the apparatus for the user.

The actuator 150 further comprises a compression plate 152 that is connected to the actuating element 151, such that a movement of the actuating element causes the compression plate to undergo a movement also. The actuator 150 also comprises a base plate 153 that is connected to the plunger 130, such that a movement of the plunger causes the base plate to undergo a movement also. A movement of the base plate also causes the plunger to undergo a corresponding movement.

The biasing member 160 shown in FIG. 1 is provided between the compression plate 152 and the base plate 153. The biasing member biases the compression plate and the base plate away from each other. The biasing member is an element of the apparatus that applies force to the plunger by way of the base plate linked thereto to drive the plunger from the retracted position to the inserted position within the cavity when the at least one biasing member possesses potential energy. Potential energy is imparted to the biasing member by the transition between the resting configuration and the actuation configuration as described further below. For example, the biasing member may include a compressible element that is adapted to store potential energy when compressed.

In the examples discussed herein the biasing member 160 includes a compressible element, and in particular a spring such as a compression spring. Potential energy may be imparted to the spring by bringing the compression plate and the base plate towards each other, thereby compressing the spring, during the transition between the resting configuration and the actuation configuration. In the example shown in FIG. 1, the biasing member 160 includes a pair of springs, each spring being linked to one of a pair of levers 151.

The actuator 150 may further include an arm 154 pivotably connected to the actuation element and connected to the compression plate at the end of the arm opposite to the connection between the arm and the actuation element. According to the present example shown in FIG. 1, the actuator includes a pair of arms 154, each pivotably connected to one of the pair of levers 151. The arms 154 may be connected to the levers by a pin joint 155.

As shown in FIG. 1, the biasing member 160, and in particular the spring, is held within a housing 156. The spring is held within the housing such that the spring can only move substantially along a single axis. In the example shown in FIG. 1, the base plate 153 forms a base of the housing. The housing, and more specifically one end of the housing, is pivotably connected to the plunger 130, for example by way of a pin joint 157. The combination of the housing 156, the base plate 153, the arm 154 and the compression plate 152 may operate in a manner similar to a piston as the arm and compression plate move within the housing. The base plate 153, which is provided at the end of the housing 156 opposite the end connected to the plunger 130, may include an opening, or through hole, through which the arm 154 may slidably pass. Accordingly, the base plate 153 shown in FIG. 1 is an annular plate. One end of the biasing member 160 abuts the base plate 153 forming the base of the housing 156. The arm and compression plate 152 arrangement is provided at least partially within the housing, such that the arm passes through the opening in the base plate and through the central cavity of the spring, such that the other end of the spring, opposite the end abutting on the base plate, rests on the lower surface, i.e. compression surface, of the compression plate 152. The spring is therefore compressed by the compression plate moving towards the base plate and away from the connection between the housing and the plunger. The spring is therefore decompressed by the base plate moving away from the compression plate.

The springs 160 may be pretensioned before insertion into the housing, meaning that when fully extended within the housing 156 the springs are still exerting a force against the compression plate 152 and the base plate 153, and so also the plunger 130. In this way, it is possible to reduce, or eliminate, a drop-off in pressure towards the end of the brewing process as the spring is reaching maximum possible extension and the plunger is approaching the inserted position.

The apparatus 100 depicted in FIG. 1 also shows a receptacle 170 for locating adjacent the base of the cylinder 180 a quantity of ground coffee, the receptacle comprising a portafilter 172 and filter basket 174 arrangement. The filter basket holds the quantity of ground coffee and permits water, but not the coffee grounds, to pass through under pressure. The portafilter comprises a means for holding the filter basket in place, a handle, and an outlet 176 for the brewed coffee. In the example shown in FIG. 1, projections 178 on the exterior of the portafilter engage thread portions on the apparatus to hold the portafilter sealed tightly against the base of the cylinder 180.

The receptacle 170 for locating adjacent the base of the cylinder 180 a quantity of ground coffee may also include a restrictor, which acts to restrict the flow of water through the ground coffee under the pressure of the driven plunger 130. By providing such a restrictor, the pressures necessary for brewing espresso coffee may be reached by the apparatus without relying on the fineness of the ground coffee being provided by the user. Thus, the restrictor may improve the ease of use of the apparatus, particularly for an unskilled user, and improve the quality of the brewed coffee.

The operation of the apparatus 100 will now be described with reference to FIGS. 1 to 3. The apparatus begins in the resting configuration shown in FIG. 1, with the actuation element and the biasing member in a resting position, such that the biasing member is applying a minimum biasing force to the plunger, and the plunger in its inserted position within the cavity. As shown in FIG. 1, the actuator being in a resting position may correspond to the pair levers 151 arranged on opposite sides of the cylinder being in a lowered position, adjacent the cylinder, and the biasing member 160 being in a resting position may correspond to the springs being in a state of maximum possible, as limited by the housing 156, decompression.

With the apparatus 100 in this state, the user may provide the apparatus with the ground coffee to make the espresso coffee. For example, the user may fill a filter basket 174 with a quantity of ground coffee and position the filter basket adjacent the base of the cylinder with a means to hold it in place, such as with a portafilter 172. The user may then provide liquid, such as heated water, to the cavity 120 within the cylinder. The liquid may be provided to the cylinder through an opening in the top of the cylinder. In the examples discussed herein, the liquid received in the cavity may be water heated to between 90° C. to 96° C.

After the ground coffee and the liquid have been provided to the apparatus 100, the user use the actuator to change the configuration of the apparatus from the resting configuration to the actuation configuration. For example, the user may raise the pair of levers 151 from a lowered position to a raised position in a first movement, i.e., the user may perform a pivotal movement with the levers in a first direction. As the arm 154 and housing 156 are rigid and the compression plate 152 is abutting the housing, such a movement with the levers would cause the arm 154, compression plate 152, housing 156, base plate 153 and biasing member 160 to all move in response to the movement of the levers without the compression plate and base plate approaching each other or the biasing member being compressed. Accordingly, the fixed connection points between the actuation element and compression plate and between the plunger and base plate will cause the plunger 130 to slide from the inserted position to the retracted position. The plunger may include a one-way valve mechanism for allowing the liquid to pass from above the plunger head to below the plunger head as the plunger moves from the inserted position to the retracted position, which is described in further detail below with reference to FIGS. 5A and 5B.

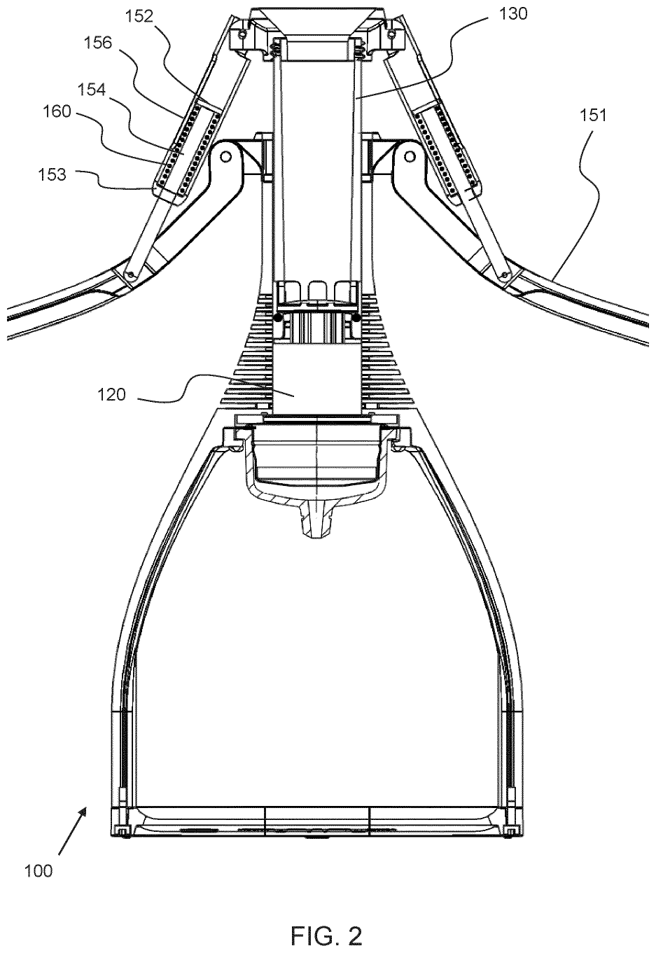

Between the resting configuration and the actuation configuration is an intermediate configuration of the apparatus where the plunger 130 is at the retracted position, the actuation element (such as the levers 151) are at an inclined position relative to the cylinder and the biasing member is still applying a minimum biasing force to the plunger. In this configuration, the liquid is held in the cavity between the plunger 130 and the ground coffee in an unpressurised state. In order to achieve the actuation configuration, the user may perform a second movement, which is opposite to the first movement, with the actuation element. For example, the user may lower the levers 151 from the raised position back to the original lowered, or resting, position. Such a movement may initial causes the plunger to slide back towards the inserted position; however, the movement of the plunger from the retracted position to the inserted position is resisted by the water between the plunger and the ground coffee. FIG. 2 shows the apparatus 100 in a state between the resting configuration and the actuation configuration.

When the force required to cause the water to pass through the ground coffee exceeds a given threshold, the movement of the levers 151 during the second movement will cause the compression plate 152 and the base plate 153 to be brought together, thereby compressing the springs. In particular, the resistance provided by the water in the cavity will prevent the plunger from reaching the inserted position within the cavity, meaning that the plunger will remain in a substantially retracted position as the levers are lowered. In order to account for this difference from the original state of the apparatus, the compression plate and base plate (which are connected to the actuation element and the plunger, respectively) are brought together and the biasing member compressed.

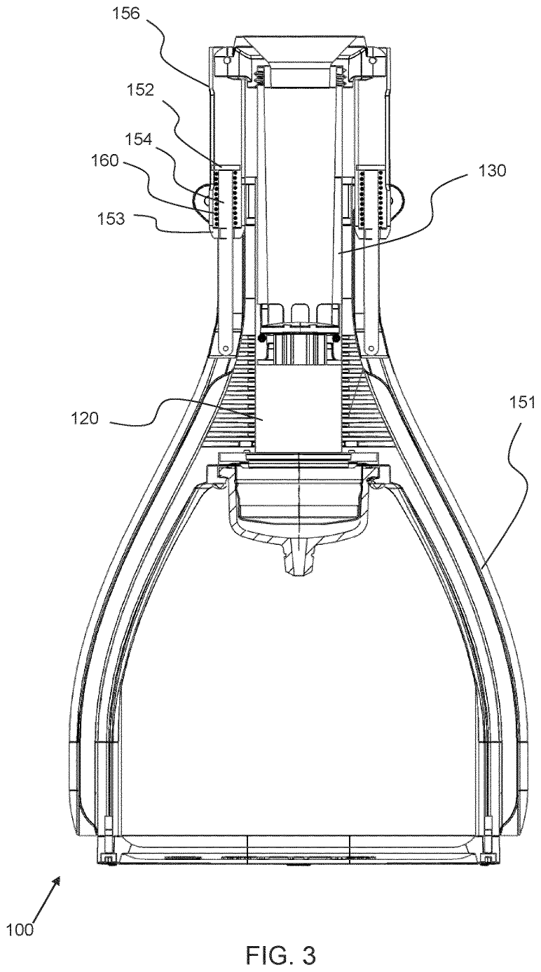

FIG. 3 shows the apparatus 100 in the actuation configuration. In particular, FIG. 3 shows the levers 151 returned to the resting position shown in FIG. 1; however, the springs 160 are fully compressed between the compression plate 152 and the base plate 153 and the plunger is in the retracted position. The compressed springs will exert a force against both the compression plate and the base plate in order to release the stored potential energy and return to their resting state. As the compression plate cannot move upwards, due to the arm 154 connecting the compression plate to the lever and fixing the position of the compression plate relative to the cylinder, the housing 156 and the attached plunger 130 are forced to move downwards, which drives the plunger towards the inserted position within the cavity 120. Thus, the driven plunger applies pressure to the liquid in the cavity to push the liquid through the ground coffee and complete the brewing process.

If the levers were directly linked to the plunger without a biasing member, such as the springs, the user would be required to apply force to the levers for the full brewing time until the plunger returned to the inserted position and the liquid had left the cavity and passed through the ground coffee. Such a continual application of force may be strenuous for certain users, particularly to reach the relatively high pressures required for making espresso coffee over a typical brewing time of roughly 30 seconds. By providing a biasing member, such as the springs, the user may complete the second movement in a single fluid motion, which may take only 2 seconds for example, after which the brewing process will be completed without any further user input being required. Further, by providing a pair of levers, each attached to the plunger by way of a separate spring, the force that needs to be applied by the user on each lever may be reduced without reducing the amount of pressure delivered to the liquid in the cavity and not adversely affecting the quality of the brewed coffee.

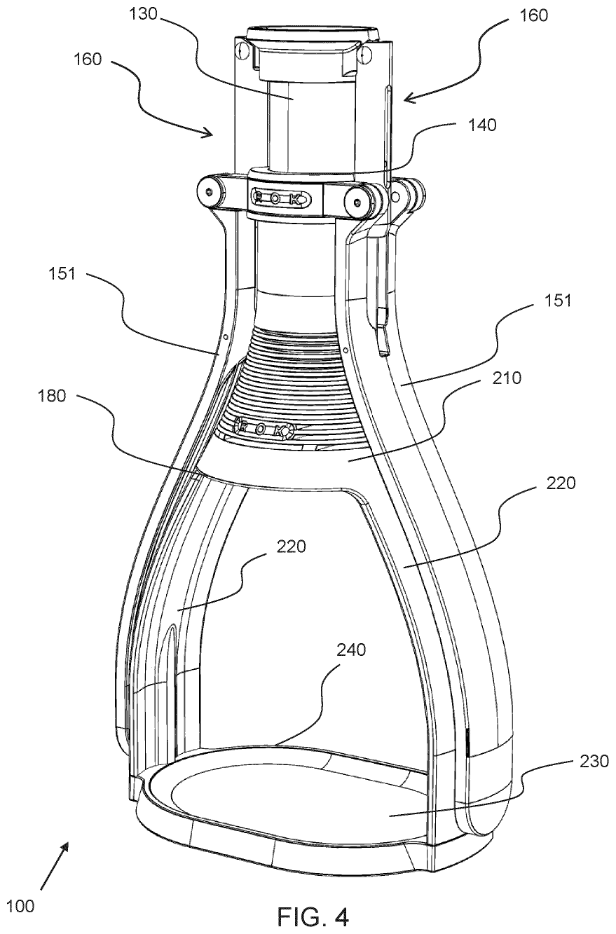

FIG. 4 shows a perspective view of the apparatus 100 described with respect to FIGS. 1 to 3. As shown in FIG. 4, the apparatus may further include a stand 210 comprising a number of legs 220, such as two legs. The stand provides a space underneath for a container, such as a cup, to catch the coffee brewed by the apparatus. In the example shown in FIG. 4, the stand comprises two legs having a generally arched shape. The apparatus may further comprise a platform 230 connected to the stand. The platform 230 may have an external rim 240 to contain any spillage. The platform may also comprise a series of raised formations (not shown) to hold a container placed on the platform out of contact with the upper side of the base plate and accordingly out of contact with any liquid which may have dropped on to the base plate during use of the apparatus.

The apparatus may also comprise a pressure gauge (not shown) for measuring the pressure within the cavity as the plunger is sliding from the retracted position to the inserted position. The measured pressure may be provided to the user by any suitable means of display such that the user may monitor the brewing of the coffee with greater accuracy.

FIGS. 5A and 5B show the head 134 of the plunger 130 in more detail. In particular, FIG. 5A shows the head of the plunger when liquid may pass through the head of the plunger and FIG. 5B shows the head of the plunger when liquid may not pass through the head of the plunger.

The head 134 of the plunger 130 is sized and shaped so as to enable it to slide axially within the cavity 120 with ease under the power of the actuator and/or the biasing member as described above. In order to seal the outside of the plunger head 300 to the interior wall of the cylinder 110, the plunger head bears an external O-ring 310.

The O-ring 310 may adopt a position adjacent a lower flange 320 moulded on the exterior periphery of the plunger head 300, or a position in which it lies against an upper flange 330, likewise integrally moulded. When the plunger 130 slides from the inserted position to the retracted position within the cavity 120, the O-ring moves to lie adjacent lower flange 320. When the plunger slides from the retracted position to the inserted position, the O-ring rolls to lie against upper flange 330.

As shown in FIGS. 5A and 5B, the plunger head comprises one or more apertures 340 which extend from adjacent lower flange 320 to approximately half-way up the space between the lower flange and the upper flange 330. When the O-ring 310 is adjacent lower flange 320, for example when the plunger is being slid from the inserted position to the retracted position, there are spaces accordingly enabling water to pass between the side of the plunger and the wall of cylinder 110, through apertures 340 and into the space below the plunger head 300. When the plunger slides from the retracted position to the inserted position, the O-ring moves to lie against the upper flange 330, thereby forming a complete seal around the entire periphery of the plunger head 300, so enabling water to be passed under pressure through the ground coffee held below the cylinder 110. In order to assist the flow of water downwardly past the plunger head 300 as it slides from the inserted position to the retracted position within the cavity, the upper edge of the piston head may be relieved by one or more notches 350.

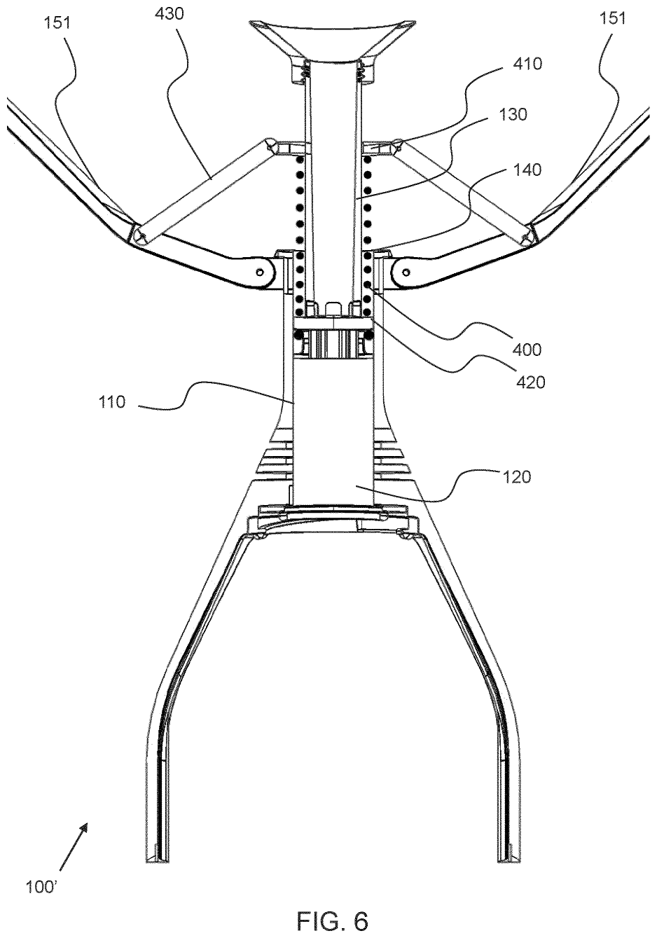

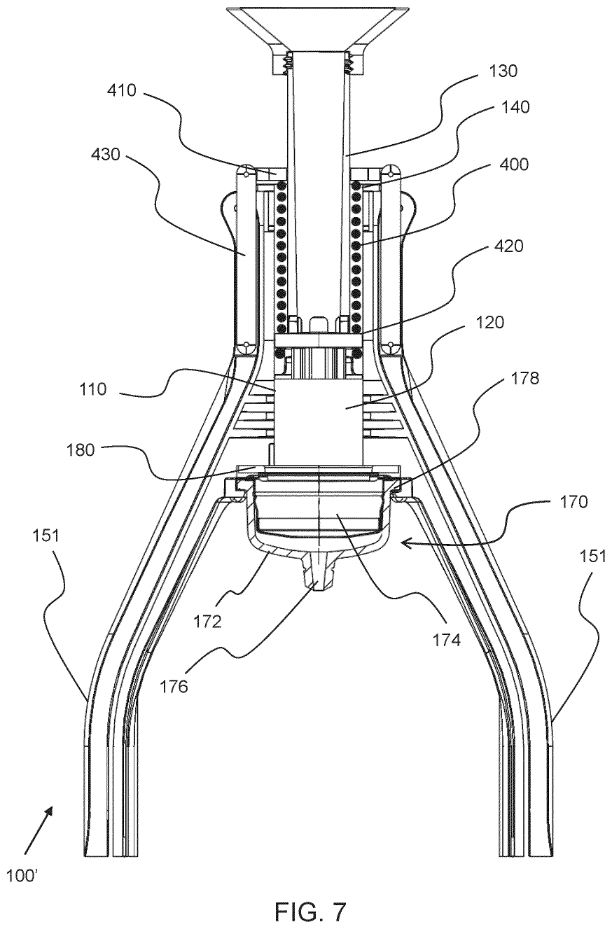

FIGS. 6 and 7 show an apparatus 100′ according to a further aspect. In particular, FIG. 7 shows the apparatus between resting and actuation configurations and FIG. 8 shows the apparatus in the actuation configuration. Reference numerals have been repeated in these figures when referring to the features already described above.

As described above, the actuator comprises biasing member for biasing the plunger 130 towards the inserted position. In the example shown in FIG. 6, the actuation element comprises a pair of levers 151 and the biasing member comprises a spring 400.

As shown in FIG. 6, the spring 400 is held at least partially within the cavity 120 of the cylinder 110. The spring is held within the cavity such that the spring can only move substantially along a single axis. The main body of the plunger 130 may pass through the central cavity of the spring, such that the spring is positioned between the main body of the plunger and the wall of the cavity.

The actuator includes a compression plate 410 that is an annular plate provided about the shaft of the plunger 130 and this is axially slidable along the shaft. The plunger, and in particular the shaft of the plunger, may pass freely through the central through hole of the compression plate. The compression plate is connected to the actuating element 151, such that a movement of the actuating element causes the compression plate to undergo a corresponding movement. The actuator also comprises a base plate 420 that is an annular plate provided about the shaft of the plunger and that is connected to the plunger 130, such that a movement of the plunger causes the base plate to undergo a corresponding movement. A movement of the base plate also causes the plunger to undergo a corresponding movement. The base plate 420 may be located proximal to the head of the plunger. In the example shown in FIGS. 6 and 7, the base plate is integrated with the head of the plunger.

The spring 400 is provided between the compression plate 410 and the base plate 420, such that one end of the spring abuts the top surface of the base plate and the other end of the spring abuts the bottom surface of the compression plate. The spring is therefore compressed by the compression plate and the base plate moving towards each other. The spring is therefore decompressed by the compression plate and the base plate moving away from each other.

Once again, the actuator may further include an arm 430 pivotably connected to the actuation element and connected to the compression plate 410 at the end of the arm opposite to the connection between the arm and the actuation element. According to the present example shown in FIG. 6, the actuator includes a pair of arms 430, each pivotably connected to one of the pair of levers 151. The arms 430 may be connected to the levers by a pin joint. Further, each arm is pivotably connected to a compression plate 410 at the end of each arm opposite the connection between each arm and the respective lever, such as by way of a pin joint.

In use, the apparatus operates much the same way as described above with reference to FIGS. 1 to 3. When the configuration of the apparatus changes from the resting configuration to the actuation configuration (e.g., in response to the levers moving from a resting position to the configuration shown in FIG. 6 and then to the configuration shown in FIG. 7) the spring 400 is compressed by the movement of the compression plate 410 towards the base plate 420. As shown in FIG. 7, the compression plate 410 is rigidly linked to the levers 151 by the arms 430, meaning that the force exerted by the spring 400 can only act to drive the base plate, and so the plunger 130 from the retracted position to the inserted position within the cavity 120. Thus, the driven plunger applies pressure to the liquid in the cavity to push the liquid through the ground coffee and complete the brewing process.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An apparatus for making espresso coffee comprising:
a cylinder defining a cavity for receiving a liquid;
a plunger axially slidable within the cavity between an inserted position and a retracted position; and
an actuator comprising a biasing member for biasing the plunger towards the inserted position,
wherein the actuator is adapted to change a configuration of the apparatus from a resting configuration in which the plunger is at the inserted position and the biasing member exerts a minimum biasing force on the plunger, to an actuation configuration in which the plunger is at the retracted position and the biasing member exerts a maximum biasing force on the plunger.

2. The apparatus as claimed in claim 1, wherein the actuator further comprises:
a compression plate; and
a base plate, wherein the base plate is connected to plunger;
wherein the biasing member is provided between the compression plate and the base plate.

3. The apparatus as claimed in claim 2, wherein:
in the resting configuration, the compression plate and the base plate have a maximum spacing between them; and
in the actuation configuration the compression plate and the base plate have a minimum spacing between them.

4. The apparatus as claimed in claim 2, wherein:
in the actuation position, the compression plate is fixed relative to the cylinder and the base plate is moveable relative to the cylinder in response the biasing force such that the plunger is drivable towards its inserted position.

5. The apparatus as claimed in claim 2, wherein the actuator comprises an actuation element, which is moveable to change the configuration of the apparatus from the resting configuration to the actuation configuration.

6. The apparatus as claimed in claim 5, wherein the compression plate is connected to the actuation element.

7. The apparatus as claimed in claim 6, wherein the actuator further comprises arm connecting the compression plate to the actuation element.

8. The apparatus as claimed in claim 7, wherein the arm is pivotably connected to the actuation element.

9. The apparatus as claimed in claim 7, wherein the arm is pivotably connected or fixedly connected to the compression plate.

10. The apparatus as claimed in claim 7, wherein the actuator further comprises a housing containing the biasing member, and wherein the base plate forms a base of the housing.

11. The apparatus as claimed in claim 10, wherein the compression plate is axially slidable within the housing.

12. The apparatus as claimed in claim 10, wherein the housing is pivotably connected to the plunger.

13. The apparatus as claimed in claim 7, wherein the base plate is an annular plate and encircles a shaft of the plunger.

14. The apparatus as claimed in claim 13, wherein the compression plate is an annular plate and encircles the shaft of the plunger.

15. The apparatus as claimed in claim 14, wherein the compression plate is axially slidable over the shaft of the plunger.

16. The apparatus as claimed in claim 5, wherein the actuation element comprises a pivotable element pivotably connected to the cylinder.

17. The apparatus as claimed in claim 16, wherein the pivotable element comprises a lever.

18. The apparatus as claimed in claim 5, wherein the actuation element comprises a pair of pivotable elements or levers arranged on opposing sides of the cylinder.

19. The apparatus as claimed in claim 1, wherein the biasing member comprises a compressible element.

20. The apparatus as claimed in claim 19, wherein the compressible element comprises a spring.

21. The apparatus as claimed in claim 20, wherein the spring is pretensioned.

22. A method for making espresso coffee using an apparatus for making espresso coffee according to any one of the preceding claims, the method comprising:
providing a quantity of liquid to the cavity of the apparatus in the resting configuration;
actuating the apparatus using the actuator to change the configuration of the apparatus to the actuation configuration;
driving the plunger towards its inserted position with the biasing force of the biasing member, thereby passing the liquid through a quantity of ground coffee.
